(19) United States
(12) Patent Application Publication
(10) Pub. No.: US 2018/0050559 A1
(43) Pub. Date: Feb. 22, 2018

(54) METHOD OF PAINTING MUTLIPLE IMAGES SELECTIVELY VIEWABLE IN DIFFERENT LIGHT CONDITIONS

(71) Applicant: Christine Marsh, Rochester, NY (US)

(72) Inventor: Christine Marsh, Rochester, NY (US)

(21) Appl. No.: 15/240,621

(22) Filed: Aug. 18, 2016

(51) Int. Cl. B44F 1/10

(52) U.S. Cl. CPC B44F 1/10

(57) ABSTRACT

An article of artwork having multiple images selectively viewable in different light conditions, the article comprises a substrate and a first image applied to the substrate using a first marking material. The first marking material is viewable under ambient and incandescent light. A second image is applied to the substrate using a second marking material comprising fluorescent compounds which are viewable under ultraviolet light. A third image is applied to the substrate using a third marking material comprising phosphorescent compounds which are viewable when the article is in a dark environment.

### BACKGROUND OF THE INVENTION

The present invention relates to works of art, and more particularly to paintings and portraits, and even more particularly to paintings and portraits of multiple images, and most particularly to paintings and portraits of multiple images where only selected images or portions of images are viewable under different light conditions.

Pieces of art, particularly paintings and portraits, are generally static images of the painting's subject. Centuries of painting have utilized numerous marking materials (charcoal, oil-based paints, chalk, pastels, latex and acrylic paints, etc.) on countless substrates (textile, wood, plaster, ceramic, plastic, glass and stone) to form the image. However, these images are typically only viewable under ambient or incandescent lighting.

More recently, artists have utilized fluorescent paints to create viewable images when subjected to ultraviolet (UV) light such as via a black light. These fluorescent images are typically outlines or highlights of the underlying image that is viewable in ambient light. For example, a portrait may be painted with oil-based paints on canvas so as to be viewable in ambient light. Fluorescent paint may then be added to outline the subject's hair and facial features such that the identity of the subject may be discerned under black light. Similarly, pieces of art have also used glow-in-the-dark paint or other phosphorescent materials to permit an image to be viewable when in a dark environment. Again, these images are generally outlines or highlights of the underlying image.

Thus, what is needed is an article or artwork, such as a painting, wherein distinct and different images are selectively viewable under different light conditions, including ambient/incandescent light, ultraviolet light and low/no light conditions. The present invention addresses these, as well as other, needs.

### SUMMARY OF THE INVENTION

It is, therefore, an aspect of the present invention to provide article of artwork having multiple images selectively viewable in different light conditions. The article comprises a substrate and a first image applied to the substrate using a first marking material which is viewable under ambient and incandescent light. A second image is applied to the substrate using a second marking material comprising fluorescent compounds. The second image is viewable under ultraviolet light. A third image is applied to the substrate using a third marking material comprising phosphorescent compounds. The third image is viewable when the article is placed in a dark environment after being exposed to light.

In a further aspect of the present invention, the substrate is selected from the group consisting of a textile, wood, plaster, ceramic, plastic, glass and stone. The first marking material may be charcoal, oil-based paint, chalk, pastels, latex paint or acrylic paint and the second marking material is transparent under ambient or incandescent light. The third marking material is further visible under ultraviolet light. A portion of the second image may overlap a portion of the first image and a portion of the third image may overlap a portion of one or both of the first image and the second image.

In another aspect of the present invention, a method of creating an article of artwork having multiple images selectively viewable in different light conditions comprises: a) applying a first marking material to a substrate to form a first image, the first image viewable under ambient and incandescent light; b) applying a second marking material comprising fluorescent compounds to the substrate to form a second image, the second image viewable under ultraviolet light; and c) applying a third marking material comprising phosphorescent compounds to the substrate to form a third image, the third image viewable under ultraviolet light or when in a dark environment.

In still another aspect of the present invention, the method may further comprise the steps of: i) creating individual sketches of each of the first image, the second image and the third image; ii) overlapping the individual sketches; and iii) selectively moving one or more of the individual sketches to correlate image overlap relating to colors and each visible image under differing light conditions prior to applying the first marking material to the substrate to form the first image.

In yet another aspect of the present invention, the individual sketches may be digital images viewable on a computing device and may be digital scans of sketches on paper. The computing device may condition the sketch of the first image to be viewable under ambient and incandescent light, condition the sketch of the second image to be viewable under ultraviolet light; and condition the sketch of the third image to be viewable in a dark environment. The computing device may then selectively simultaneously display each of the individual sketches or simulate an ambient light environment, an ultraviolet light environment or the dark environment so as to render respective sketches viewable at a time.

In a further aspect of the method, the first marking material is applied to the substrate and allowed to dry before application of the second marking material and the second marking material is applied to the substrate and allowed to dry before application of the third marking material. In a further aspect, the second and third marking materials may be applied under ultraviolet light conditions. A portion of the second image may overlap a portion of the first image and a portion of the third image may overlap a portion of one or both of the first image and the second image

In still a further aspect of the method, the substrate is selected from the group consisting of a textile, wood, plaster, ceramic, plastic, glass and stone; the first marking material is selected from the group consisting of charcoal, oil-based paint, chalk, pastels, latex paint and acrylic paint; the second marking material may be transparent under ambient or incandescent light; and the third marking material may further be viewable under ultraviolet light.

### BRIEF DESCRIPTION OF THE DRAWINGS

The invention will further be described, by way of example, with reference to the accompanying drawings:

FIG. 1 is an exemplary view of an article of artwork in accordance with an embodiment of the present invention, the artwork shown when viewed under ambient/incandescent light;

FIG. 2 an exemplary view of the article of artwork shown in FIG. 1, the artwork shown when viewed under ultraviolet light;

FIG. 3 an exemplary view of the article of artwork shown in FIG. 1, the artwork shown when viewed under dark lighting conditions;

FIG. 4 is a flow diagram of a method creating the article of artwork shown in FIGS. 1-3;

FIG. 5 is an exemplary view of a pre-production sketch of the article of artwork shown in FIG. 1 depicting the article under ambient/incandescent light;

FIG. 6 is an exemplary view of a pre-production sketch of the article of artwork shown in FIG. 2 depicting the article under ultraviolet light;

FIG. 7 is an exemplary view of a pre-production sketch of the article of artwork shown in FIG. 3 depicting the article under dark lighting conditions; and

FIG. 8 is an exemplary view of a composite view of the sketches shown in FIGS. 5-7.

### DETAILED DESCRIPTION

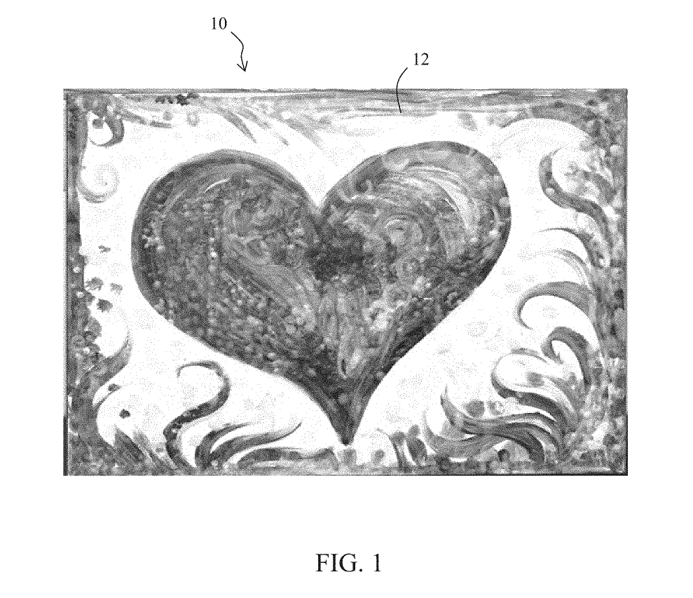

With reference to FIGS. 1-3, an embodiment of an article of artwork is generally indicated by reference numeral 10. Artwork 10 may be, for instance, a painting or portrait, but it should be understood by those skilled in the art that other articles, such as apparel, glassware, sculpture, etc., may be produced in accordance with the teachings of the present invention. For the sake of clarity and without limiting solely thereto, artwork 10 will be referred to as a painting throughout the remainder of the description. As shown in FIGS. 1-3, painting 10 may include multiple images 12, 22, 32 which are selectively viewable under different lighting conditions as will be disclosed more fully below.

Turning now to FIG. 1, painting 10 may include a first image 12 applied to the surface of a substrate, such as but not limited to a textile, wood, plaster, ceramic, plastic, glass, stone and the like so as to be viewed. For the sake of clarity and without limitation thereto, the substrate will be referred to as a canvas throughout the remainder of the description. First image 12 may be comprised of a first marking material such as, but not limited to, charcoal, pencil, oil-based paints, chalk, pastels, latex paints, acrylic paints, water color paints and the like. The first marking material may be viewable under ambient or incandescent lighting and may not include fluorescent or phosphorescent materials. Thus, under normal day light conditions, first image 12 may be viewed. It should be noted that for substances which do not fixedly adhere to the surface of the substrate (such as charcoal or pastels), a fixative agent may be applied over first image 12. Examples of suitable fixative agents include a fixative spray or a varnish as is known in the art.

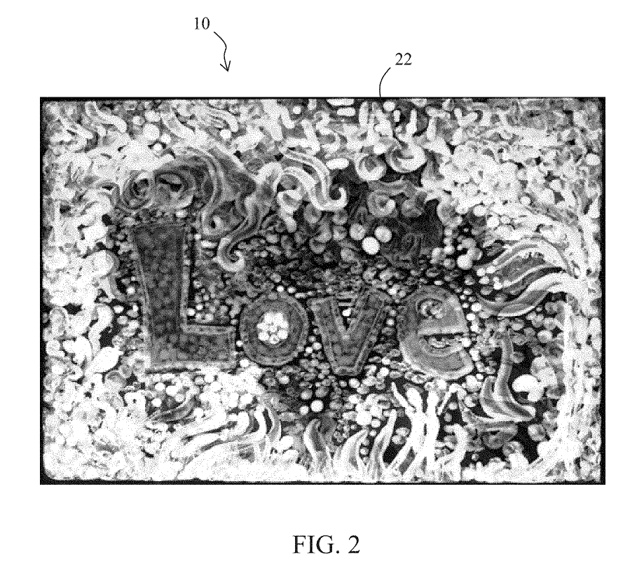

With reference to FIG. 2, a second image 22 may applied to the canvas of painting 10 and may overlap a portion of first image 12. Second image 22 may be comprised of a second marking material (such as those listed above with regard to first marking material) with the exception that the second marking material further includes fluorescent compounds which fluoresce when exposed to ultraviolet (UV) light, such as that provided by a black light. In one aspect of the present invention, second image 22 is comprised of a marking material which is transparent under ambient/incandescent lighting conditions such that only first image 12 is viewed when the painting is under these conditions. However, when exposed to UV light, the second marking material may emit light such that second image 22 becomes viewable while first image 12 becomes less discernable, with first image 12 being no longer viewable under appropriate lighting conditions (i.e. in a dark room lit only using a black light such that there is little to no ambient or incandescent light with which to view the first image).

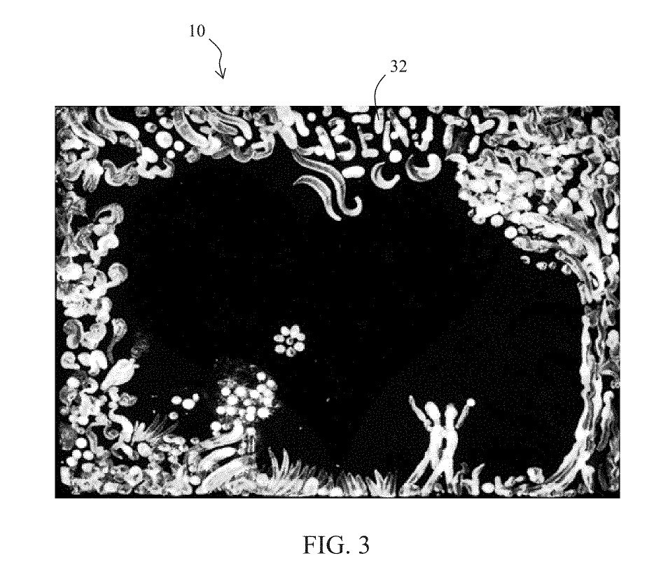

Turning now to FIG. 3, a third image 32 may be applied to the canvas of painting 10 and may overlap a portion of one or both of first image 12 and second image 22. Third image 32 may be comprised of a third marking material (such as those listed above with regard to first marking material) with the exception that the third marking material further includes phosphorescent compounds which may emit visible light when painting 10 is in a darkened environment after being exposed to light. The third marking material may also be viewable when exposed to UV light, but in one aspect of the present invention, may be transparent under ambient/incandescent lighting conditions.

In this manner, only first image 12 may be viewed when under ambient/incandescent lighting conditions. However, when exposed to UV light in a darkened room, both the second marking material and third marking material may emit light such that second image 22 and third image 32 become viewable while first image 12 becomes less discernable as described above. Upon termination of UV light exposure in a darkened room, the fluorescent second marking material will cease to emit light while the third marking material will continue to phosphoresce. As a result, third image 32 will remain viewable while second image 22 is substantially non-discernible. Because the third marking material is viewable under UV light, the placement and any selective mixing/overlapping of third marking material and second marking material needs to be carefully controlled and accounted for when creating painting 10. In accordance with an aspect of the present invention, the best viewing sequence of painting 10 may be to first view first image 12 under ambient/incandescent light, followed by viewing second and third images 22, 32 under UV light, followed by viewing third image 32 in a dark environment.

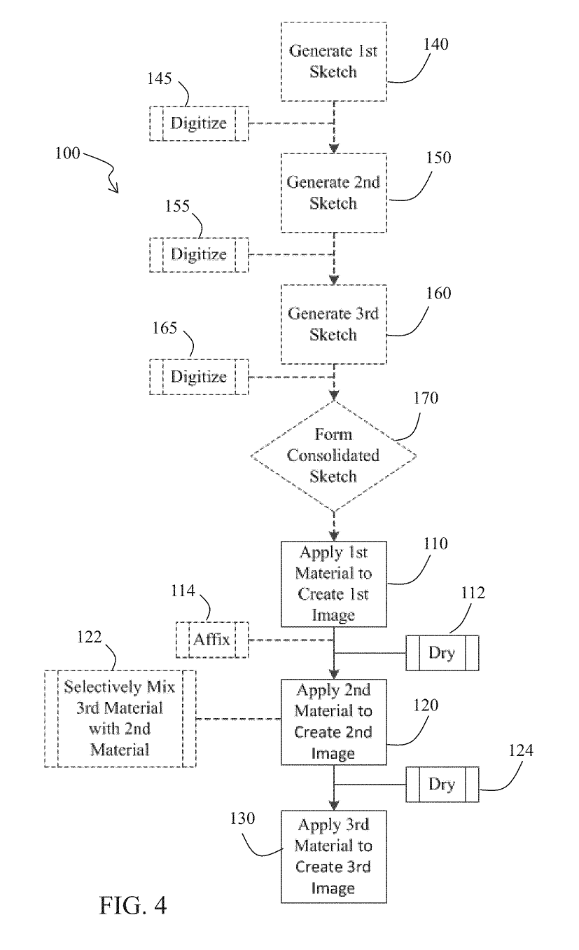

Turning now to FIGS. 4-8, an embodiment of a method 100 for creating an article of artwork having multiple images selectively viewable in different light conditions may generally begin with application of a first marking material to an underlying substrate (i.e., canvas) at step 110. Before application of the second marking material in step 120, the first marking material may be allowed to dry at intermediate step 112. As discussed above, a fixative agent may also be applied following application of the first marking material at step 114 so as to affix the marking material to the canvas. The fixative agent may be allowed to dry at intermediate step 112. With first image 12 affixed to the canvas (following step 110 and/or step 114), the second marking material may then be applied to the canvas at step 120 so as to create second image 22. The second marking material may also be selectively mixed with third marking material at optional step 122 so that a combined second/third material may be applied to desired areas at the same time. Following application of the second marking material (step 120) and/or optional application of mixed second and third marking materials (step 122), second image 22 may be allowed to dry at step 124. Drying step 124 may allow the applied materials to fix to the canvas and/or underlying first marking material prior to application of third marking material in step 130.

In accordance with an aspect of the present invention, the first image must be fixed and dried prior to application of the second marking material. Should the first image not be sufficiently dry, unwanted bleeding or mixing of the second marking material into the first marking material may result. In a further aspect of the present invention, the first image must be completed and dried prior to application of any second marking material because any edits or touch-ups to the first image after application of the second marking material may interfere with, or prevent, the desired fluorescence which generates the second image. By way of example, multiple coats of second marking material may be applied to the canvas to create the desired shade of color/fluorescent intensity of the second image. Should any first marking material be later added which overlaps the multiple coats of second marking material, the desired second image may be compromised. Retouching the second image would also be extremely difficult, if not impossible, due to the finely controlled application and overlapping of the multiple coats of second marking material. As a result, the second image may not fluoresce as intended or wanted.

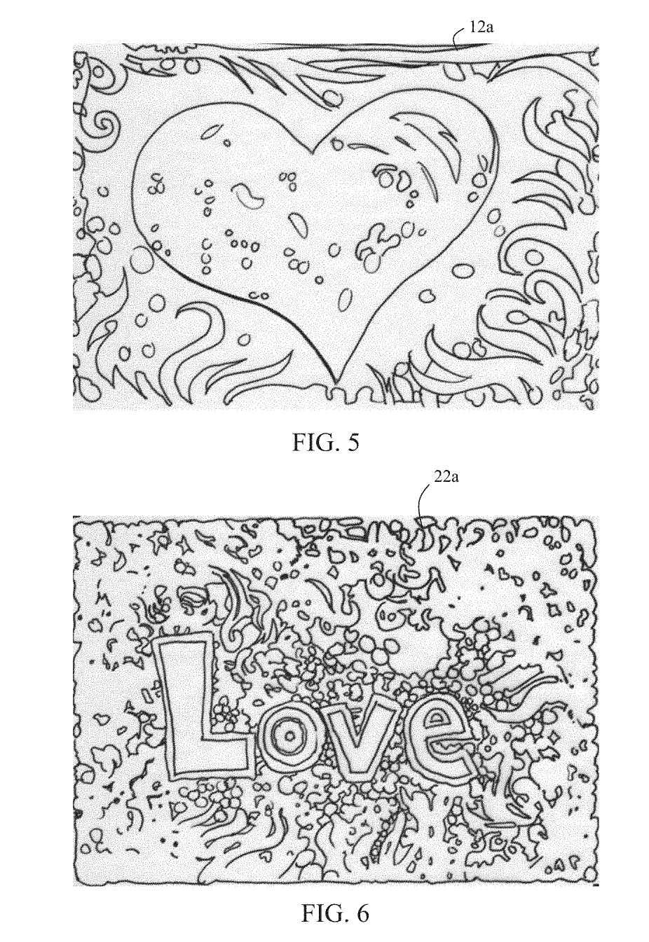

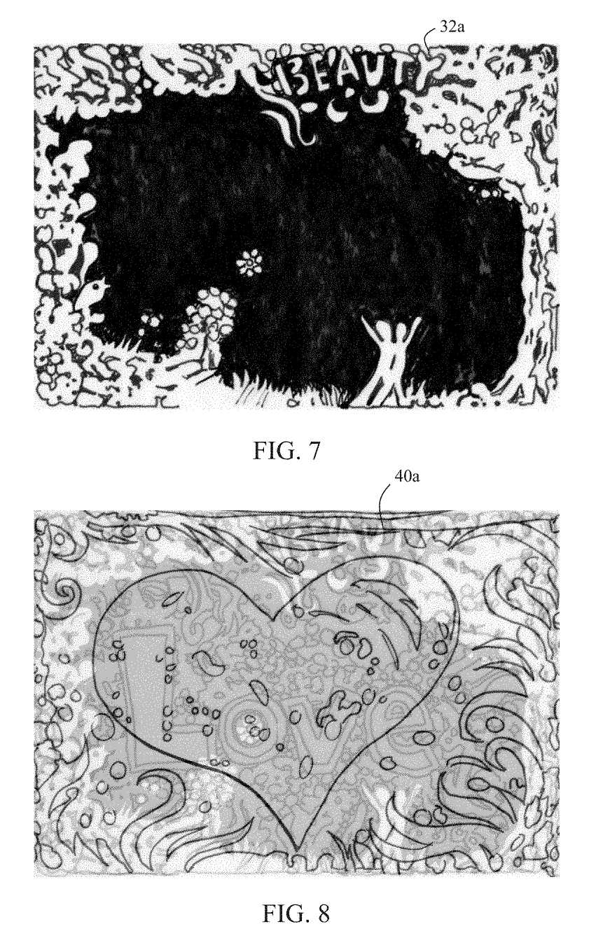

To aid in the creation of painting 10, method 100 may further include additional steps 140-170 as described more fully below. That is, prior to application of any marking material to the canvas, a number of sketches may be generated. For instance, at step 140, a sketch of first image 12a may be created (see FIG. 5). Sketched first image 12a generally includes the major elements of the desired final painting of first image 12 as see in FIG. 1. Similarly, a sketch 22a (FIG. 6) of second image 22 is created in step 150 and a sketch 32a (FIG. 7) of third image 32 is created in step 160. At step 170, each of sketched images 12a, 22a, 32a may then be overlaid upon one another to form a composite sketch 40a (see FIG. 8). One or more of sketches 12a, 22a or 32a may then be manipulated so as to correlate image overlap relating to color and viewable image under the different light conditions. By way of example, sketched images 22a and 32a may be selectively arranged such that the phosphorescent material of the third marking materials does not interfere with the desired second image 22 created by the fluorescing second marking material.

To further aid in the creation of painting 10, each sketch 12a, 22a, 32a may be digitized at steps 145, 155, 165 respectively, such as via a color scanner, and uploaded to a computing device, such as but not limited to, a personal computer, laptop, tablet or smart phone (not shown). The computing device may selectively simultaneously display and overlap the image of each of the individual sketches to assist in manipulating the sketches as described above. The computing device may also selectively simulate an ambient light environment, an ultraviolet light environment and/or a dark environment so as to render respective sketches 12a, 22a, 32a viewable at a time when under the proper lighting conditions.

Although the invention has been described with reference to preferred embodiments thereof, it is understood that various modifications may be made thereto without departing from the full spirit and scope of the invention as defined by the claims which follow.

What is claimed is:

1. An article of artwork having multiple images selectively viewable in different light conditions, the article comprising:
a) a substrate;
b) a first image applied to the substrate using a first marking material viewable under ambient and incandescent light;
c) a second image affixed to the substrate using a second marking material comprising fluorescent compounds, the second image viewable under ultraviolet light; and
d) a third image applied to the substrate using a third marking material comprising phosphorescent compounds, the third image viewable when the article is in a dark environment after being exposed to light.

2. The article of claim 1 wherein the substrate is selected from the group consisting of a textile, wood, plaster, ceramic, plastic, glass and stone.

3. The article of claim 1 wherein the first marking material is selected from the group consisting of charcoal, oil-based paint, chalk, pastels, latex paint and acrylic paint.

4. The article of claim 1 wherein the second marking material is transparent under ambient or incandescent light.

5. The article of claim 1 wherein the third marking material is further visible under ultraviolet light.

6. The article of claim 1 wherein a portion of the second image overlaps a portion of the first image and a portion of the third image overlaps a portion of one or both of the first image and the second image.

7. A method of creating an article of artwork having multiple images selectively viewable in different light conditions, the method comprising:
a) applying a first marking material to a substrate to form a first image, the first image viewable under ambient and incandescent light;
b) applying a second marking material comprising fluorescent compounds to the substrate to form a second image, the second image viewable under ultraviolet light; and
c) applying a third marking material comprising phosphorescent compounds to the substrate to form a third image, the third image viewable under ultraviolet light or when in a dark environment.

8. The method of claim 7 further comprising the steps of: prior to step a)
i) creating individual sketches of each of the first image, the second image and the third image;
ii) overlapping the individual sketches; and
iii) selectively manipulating one or more of the individual sketches to correlate image overlap relating to colors and each visible image under differing light conditions.

9. The method of claim 8 wherein the individual sketches are digital images viewable on a computing device.

10. The method of claim 9 wherein the computing device:
a) conditions the sketch of the first image to be viewable under ambient or incandescent light,
b) conditions the sketch of the second image to be viewable under ultraviolet light; and
c) conditions the sketch of the third image to be viewable in a dark environment,
wherein the computing device selectively simultaneously displays each of the individual sketches or simulates an ambient light environment, an ultraviolet light environment or the dark environment so as to selectively render respective sketches viewable.

11. The method of claim 7 wherein the first marking material is applied to the substrate and allowed to dry before application of the second marking material.

12. The method of claim 11 wherein the second marking material is applied to the substrate and allowed to dry before application of the third marking material.

13. The method of claim 7 wherein the second marking material is applied under ultraviolet light conditions.

14. The method of claim 7 wherein the third marking material is applied under ultraviolet light conditions.

15. The method of claim 7 wherein the wherein the substrate is selected from the group consisting of a textile, wood, plaster, ceramic, plastic, glass and stone.

16. The method of claim 7 wherein the wherein the first marking material is selected from the group consisting of charcoal, oil-based paint, chalk, pastels, latex paint and acrylic paint.

17. The method of claim 7 wherein the wherein the second marking material is transparent under ambient or incandescent light.

18. The method of claim 7 wherein the wherein the third marking material is further visible under ultraviolet light.

19. The method of claim 7 wherein a portion of the second image overlaps a portion of the first image and a portion of the third image overlaps a portion of one or both of the first image and the second image.
